(19) United States
(12) Patent Application Publication
(10) Pub. No.: US 2023/0268868 A1
(43) Pub. Date: Aug. 24, 2023

(54) VEHICLE-MOUNTED PHOTOVOLTAIC POWER GENERATION DEVICE FOR LARGE VEHICLES

(71) Applicant: Jie LI, Nanning (CN)

(72) Inventor: Jie LI, Nanning (CN)

(21) Appl. No.: 17/880,638

(22) Filed: Aug. 3, 2022

Related U.S. Application Data
(63) Continuation of application No. PCT/CN2022/077174, filed on Mar. 1, 2022.

(30) Foreign Application Priority Data
Feb. 22, 2022 (CN) 202210159596.4

(51) Int. Cl. H02S 10/40; H02S 20/32; H02S 30/10

(52) U.S. Cl. CPC H02S 10/40; H02S 20/32; H02S 30/10; H02J 2300/24; B60L 53/51

(57) ABSTRACT

The present invention relates to new energy vehicle field, and more particularly to a vehicle-mounted photovoltaic power generation device for large vehicles. at present, large-scale new energy vehicles such as buses, passenger carriage, trucks, and touring car, use photovoltaic power generation technology with fixed brackets to increase their cruising range, however, due to its low power generation and untraceable defects, it is a technical problem that needs to be solved urgently in the field of new energy vehicles. the invention provides a vehicle-mounted fixed type and tracking type integrated technology is not only enhances wind resistance, but also improves power generation efficiency, and builds a 2-dimensional tracking photovoltaic power generation device without photoelectric sensors, compared with products that cannot track, the solar power generation of the present invention is increased by more than 40% on average.

### CROSS REFERENCE OF RELATED APPLICATION

This is a Continuation Application of the International Application PCT/CN2022/077174, filed Mar. 1, 2022, which claims priority under 35 U.S.C. 119(a-d) to CN 202210159596.4, filed Feb. 22, 2022.

### FIELD OF INVENTION

The present invention relates to new energy vehicle field, and more particularly to a vehicle-mounted photovoltaic power generation device for large vehicles.

### DESCRIPTION OF RELATED ARTS

In order to meet the environmental protection needs of carbon peaking, carbon neutrality and subsequent sustainable development needs, in addition to passenger cars, large vehicles of new energy vehicles, such as buses, passenger carriage, trucks, and touring car, will replace the same type of fuel vehicles and will become the future development trend, however, the lack of cruising range is a bottleneck that plagues the smooth development of new energy vehicles, therefore, photovoltaic power generation will be widely used in the new energy vehicle industry, at present, large new energy vehicles use photovoltaic power generation technology with fixed brackets to increase the cruising range, but due to its low power generation and untraceable defects, it is difficult to meet the requirements of large new energy vehicles.

### Technical Problem to be Solved

How to solve the vehicle-mounted photovoltaic power generation device for large vehicles has poor wind resistance, is not only traceable but also has practical value is a technical problem that needs to be solved urgently in the field of new energy vehicles.

### What is the Technical Solution

In view of the above-mentioned shortcomings, the present invention provides a vehicle-mounted photovoltaic power generation device for large vehicles, so that the above-mentioned technical problems are solved.

In order to achieve the above objective, the technical solution of the present invention is: A vehicle-mounted photovoltaic power generation device for large vehicles, which includes a turntable, a tracking bracket, and the photovoltaic panels, the tracking bracket is a 2-dimensional tracking, which is divided into two modes: lifting or rotating, in the lifting-type 2-dimensional tracking mode, it includes the photovoltaic panels, motor, the gear, the base pillar, the shaft, the pallet, the safety beam, the pillar, electronic locks or electromagnets, there are two types of electronic locks, the first is an electronic lock using RFID technology, which divided into three different types, namely passive RFID and active RFID and semi-active RFID, the second is the electronic lock using wireless network technology, and the shape of the pallet, the base pillar, and the pillar is polygonal or circular, an I-shaped plate is fixed above the shaft A of the motor A and the rotating shaft A, and the two wings of the I-shaped plate are fixed on the base pillar, there are two adjacent round holes on the I-shaped plate, and bearings are installed at the round holes, the rotating shaft A passes through the round hole in the center, the lower end is connected to the bearing, and the bearing is fixed on the bracket, the shaft A of the motor A passes through another round hole, and the bearing bracket and the casing of the motor A are fixed at the bottom of the base pillar, a pair of gears A and B are correspondingly installed on the shaft A and the rotating shaft A on the I-shaped plate, and the gears A and B mesh with each other, the hollow tube in the center of the pallet is threaded with the rotating shaft A, and moves up and down on the rotating shaft A, the three pillars are fixed on the pallet in a triangular shape, the pillars are divided into two types: pillar C and pillar D, two pillars C are installed side by side in a row, pillar D is installed in the middle of the two pillars C, a polygonal or circular plate or lid is fixed at the top of each pillar, the hinged or fixedly connected member is respectively installed on the top of pillar C or pillar D, the pillar D is a lifting electric pillar, including motor B, rotating shaft B, hollow tube B, the hollow tube B is headedly connected with the rotating shaft B, and moves up and down on the rotating shaft B, the rotating shaft B is fixed on the shaft of the motor B, and the height of the three pillars is the same, the length of the hollow tube B is the same as the height H of the rotating shaft B, H1 is the height of the hollow tube B ascending and descending, ½ H≤H1≤⅔ H, the top of the base pillar is fixed with a cover, which is not connected with the three pillars, and the top of the rotating shaft A is fixed on the cover through a bearing, a battery is installed at the bottom of the base pillar, the top of the base pillar protrudes on the top surface of the vehicle roof, and the bottom is fixed on the turntable, the turntable is a polygonal or circular T-shaped pillar, the universal wheels are installed around the bottom surface of the turntable, and the anti-wind device is installed between the universal wheels and the hollow tube of the turntable, the anti-wind device is composed of beams and grooved track, one end of the beam is hinged or fixed on the bottom surface of the turntable, and the other end is fixed with a polygonal or circular fastener, which is inserted into the groove track, the shape of the groove track is circular, the cross section is trapezoidal, and it is fixed at the bottom of the sleeve, the sleeve is a polygonal or circular hollow column, the hollow tube of the turntable is fixed on the shaft C of the motor C, and the casing of the motor C is fixed on the bottom of the sleeve, a dust-proof belt is installed between the top of the sleeve and the base pillar, its material is divided into two types: rigid material or soft material, and it is flush with the roof of the vehicle, the rigid dust-proof belt is not connected with the base pillar, while the soft dust-proof belt can be connected with the base pillar, the side walls and bottom of the sleeve are fixed on the support frame, and the support frame is fixed on the frame of the vehicle body, a polygonal or circular safety beam is installed on the roof of the vehicle, and the above electronic locks or electromagnets are installed in the safety beam, between the inner side of the safety beam and the protruding part of the base pillar, the above-mentioned anti-wind device is installed, install grooved rails or beams on its inner side, the sides of the protruding parts of the base pillar are hinged or fixedly mounted with beam with fastenings or fixedly mounted track, the quantity of photovoltaic panels are divided into two types, piece or multiple, when there are multiple photovoltaic panels, multiple photovoltaic panels are fixed as a whole by using T-shaped plates and fixing members, the hinged or fixed components corresponding to the pillars C or D are installed on the back of the photovoltaic panel or on the T-shaped panel, the electronic locks or electromagnets corresponding to the safety beam are also installed on the back of the photovoltaic panel, in the rotary-type 2-dimensional tracking mode, it includes the turntable, the Π-shaped or I-shaped bracket, the tubular drive, the sleeve, the safety beam, and the frame, the shape of the frame is polygon or circle, the electronic locks or electromagnets are installed on the back of the frame, and one end of the frame is fixed on the hollow tube in the tubular drive device, the tubular driving device includes a hollow tube, the tubular motor, driving wheels or gears, the drive wheels or gears are connected to the motor shaft and fixed inside the hollow tube, the tubular motors are placed in the hollow tube, and the tubular motors are fixed on the motor bases, the motor bases are fixed on the fastening components, and the two ends of the hollow tube are respectively connected to the runner of the fastening component, and the fastening component is fixed on the bracket, the bracket is fixed on the Π-shaped or I-shaped bracket, and the bottom of the Π-shaped or I-shaped bracket is fixed on the turntable, the top is the cover of the sleeve, which is suspended on the top of the sleeve and is not connected to it, and is circular in shape, the anti-wind device on the safety beam is connected with the bracket of the fastening component, and the photovoltaic panels are installed in the frame, the top surface of the sleeve protrudes or recesses into the vehicle, when recessed into the vehicle, the top surface of the Π-shaped or I-shaped bracket is flush with the roof surface of the vehicle, the drive of the motor will be controlled by the angle tracking controller, the electronic module of the controller includes the main chip, multi-axis angle sensor or tilt sensor, GPS satellite positioning, clock chip, and motor drive module, the angle tracking controller is mounted parallel on the back of the photovoltaic panel, about the adjustment of the azimuth angle, in the morning and afternoon time periods, it is adjusted every δ minutes, and no adjustment is made at noon time period, the adjustment of the inclination angle is divided into two types: several adjustments within 3 times a day or many times adjustments more than 3 times, the angle tracking controller adopts the working principle of non-inductive tracking without photoelectric sensors, about the adjustment of inclination angle, when it is a lifting-type 2-dimensional tracking mode, in several adjustment modes, a fixed inclination angle is used to adjust, the rising height of the pillar D in the morning and afternoon periods is H1, and the lowering height in the noon period is H1, and the corresponding inclination angle value is θ or 0, input the inclination angle value of θ, 0 and the corresponding time period into the memory module of the controller in advance, when receiving the adjustment signal, the angle tracking controller adjusts the height of the rising or lowering H1 of the pillar D according to the inclination angle of θ or 0; in the many times adjustment mode, real-time inclination is used to adjust, in the morning and afternoon time periods, the inclination angle is adjusted λ times within δ minutes, and no adjustment at noon time period, input the adjust timetable into the memory module of the controller in advance, it uses the module or inclination sensor in the multi-axis angle sensor to detect the angle value in real time to determine the size of the inclination angle adjustment, the inclination angle α at the beginning of each adjustment is the real-time inclination angle at that time, the multi-axis angle sensor module is divided into 3 combination types: the first combination is multi-axis gyroscope and multi-axis acceleration, the second combination is multi-axis gyroscope and multi-axis angle, and the third combination is multi-axis gyroscope and multi-axis acceleration and multi-axis angle, when receiving the adjusted signal, the core chip of the multi-axis angle sensor or the inclination sensor uses its own digital operation processor to go through the algorithm of attitude calculation or Kalman filtering, the real-time inclination value α after the operation is output through the main interface, and sent to the main controller of the main chip after being converted by the analog-to-digital converter, the main controller drives the rising or lowering of the pillar D according to the inclination angle value α, so that the inclination angle adjustment of the photovoltaic panel becomes α, the adjusted inclination angle value is again converted by the analog-to-digital converter and sent to the main controller of the main chip, the main controller then compares the input value with the inclination angle value α to determine whether the inclination angle of the photovoltaic panel that has been adjusted in place is within the error range, and according to this, the motor control module of the pillar D is controlled, so as to complete the adjustment of the inclination angle α once, in the rotating 2-dimensional tracking mode, the inclination angle of the photovoltaic panel is the same as the rotation angle of the tubular drive device, in the mode of several adjustments is the same as the lift type, a fixed inclination angle is used as well, the rotation angle of the tubular drive device in three time periods is the same as the inclination angle values β and 0 in the memory module; in the mode of many times adjustment is the same as the lift type, but the adjustment of the inclination angle α is completed by driving the tubular drive device to rotate the angle of α, the adjustment of the azimuth angle, the adjustment of the azimuth angle of the lift mode and the rotary mode are the same, the timetable of δ times adjustment is input into the memory module of the controller in advance, when the predetermined adjustment time is reached, the angle tracking controller receives the GPS real-time positioning information, through the calculation of the control module of the main chip, a real-time azimuth angle value φ facing east or west is obtained, the main controller drives the turntable rotation angle φ according to the azimuth angle φ, so that the azimuth angle of the photovoltaic panel is transformed into φ, the error detection method after azimuth adjustment is the same as that of inclination angle, it is characterized in that: the tracking bracket is installed in the fixed bracket, which not only enhances the wind resistance performance, but also builds a 2-dimensional tracking type and fixed type integrated photovoltaic power generation device without photoelectric sensors, the angle adjustment of the photovoltaic panel will adopt time timing, and implementation by the angle tracking controller which will control the rotation of the turntable or the rising or lowering of the pillar D or the rotation of the tubular drive device respectively.

### Beneficial Effect

A vehicle-mounted photovoltaic power generation device for a large vehicle of the present invention, it solves the technical problem that the photovoltaic power generation device for large vehicles can not only tracking, but also has practical value.

### BRIEF DESCRIPTION OF THE DRAWINGS

FIG. 1 is the top plan view of the lifting type: 1—photovoltaic panels, 2—T-shaped plate on the back of the photovoltaic panel, 3—cap of the base pillar, 4—pillar C, 5—rotating shaft A, 6—pillar D, 7—electronic locks or electromagnets, 8—safety beam, 9—base pillar;

FIG. 2 is the front view of the lifting type storage state: 10—hinge member on pillar C, 11—fixed member on pillar D, 12—sleeve, 13—gear A, 14—hollow tube in the center of the pallet, 15—pallet, 16—gear B, 17—motor B, 18—shaft B; FIG. 3 is the front view of the lift type photovoltaic panel when it is raised into place: 19—wing of the I-shaped plate, 20—I-shaped plate, 21—battery, 22—bearing, 23—bracket of the bearing, 24—motor A, 25—motor shaft A;

FIG. 4 is the front view of the lift-type photovoltaic panel in the tilted state: 26—beam of the anti-wind device, 27—groove track, 28—hollow tube in the center of the turntable, 29—turntable, 30—universal wheel of the turntable, 31—motor C, 32—motor shaft C, 33—vehicle roof; FIG. 5 is front view of the rotating mode when the sleeve bulge the roof of vehicle and the photovoltaic panel horizontal in state; 34—frame, 35—bracket connecting the frame and the tubular drive device, 36—tubular drive device, 37—bracket of the tubular drive device;

FIG. 6 is front view of the rotating mode when the sleeve is recessed into the roof of vehicle and the photovoltaic panel in the tilted state; 38—Π I-shaped or I-shaped bracket.

### DETAILED DESCRIPTION OF THE PREFERRED EMBODIMENT

### Preferred Embodiment of the Present Invention

In order to deepen the understanding of the present invention, the present invention will be further described below with reference to the accompanying drawings. This embodiment is only used to explain the present invention, and does not constitute a limitation on the protection scope of the present invention.

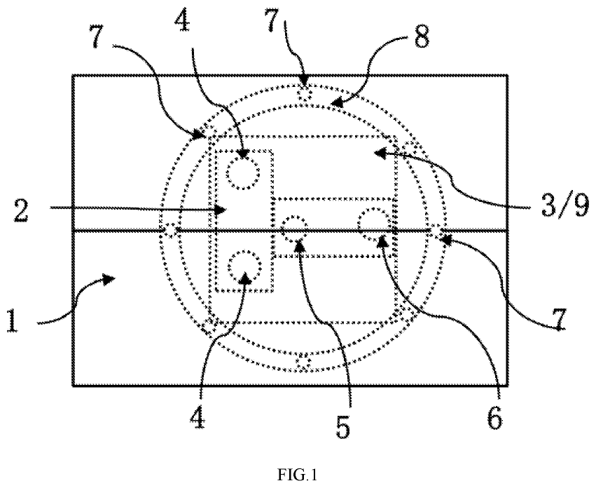

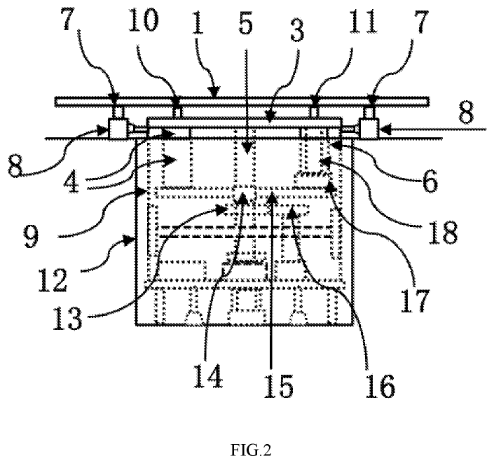

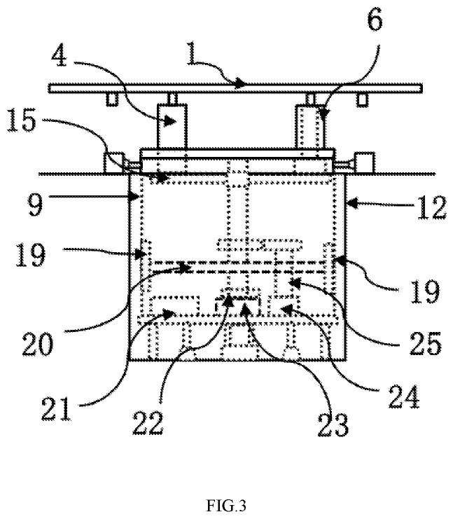

Refer to FIGS. 1-4, the two photovoltaic panels 1 of lift type are fixed as a whole with T-shaped panels 2, the back of the photovoltaic panel is fixed with the electronic lock or electromagnet 7 in a ring shape, the hinged member 10 and the fixed member 11 on the T-plate 2 are respectively connected with the members on the top of the pillar 4 and the pillar 6 to form two hinged devices and a fixed device, both the pillar 4 and the pillar 6 are fixed on the pallet 15, and the hollow tube 14 in the center of the pallet 15 is threaded connection with the rotating shaft 5, the I-shaped plate 20 is fixed on the base pillar 9 through two wings 19, there are two circular holes on the I-shaped plate 20, the rotating shaft 5 passes through the central circular hole, and the motor shaft 25 passes through the other circular hole, a pair of gears 16 and 13 are correspondingly installed on the motor shaft 25 and the rotating shaft 5 on the I-shaped plate 20, and the gears 16 and 13 mesh with each other, the lower end of the rotating shaft 5 is connected to the bearing 22, the bracket 23 of the bearing 22, the battery 21, and the frame of the motor 24 are all fixed on the bottom of the base pillar 9, the top of the base pillar 9 is fixed with the cap 3, the top of base pillar 9 protrudes above the vehicle roof 33, the safety beam 8 is fixed on the vehicle roof 33, on which the electronic lock or electromagnet 7 corresponding to the photovoltaic panel 1 is installed, the bottom of the base pillar 9 is fixed on the turntable 29, and the universal wheel 30 are installed around the back of the turntable 29, the hollow tube 28 in the center of the turntable is fixed on the shaft 32 of the motor 31, anti-wind device are installed between the hollow tube 28 and the universal wheel 30 and between the safety beam 8 and the base pillar 9, the groove tracks 27 in the anti-wind device is respectively fixed on the inner side of the safety beam 8 or the bottom of the sleeve 12, the beam 26 are connected to the bulge of the base column 9 or the back of the turntable 29, the top of the sleeve 12 is flush with the vehicle roof 33, which bottom and the surrounding are fixed on the support frame, and the support frame is fixed on the skeleton of the vehicle body, the angle tracking controller is installed in parallel on the back of the photovoltaic panel, and connect the waterproof male and female connectors between the angle tracking controller, the motor and the battery to each other, and the installation of the 2-dimensional tracking photovoltaic power generation device is completed, please refer to FIG. 2.

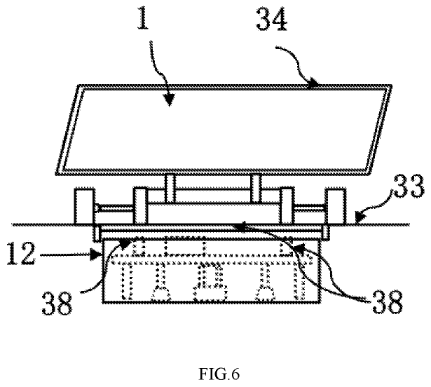

Refer to FIGS. 5-6, the photovoltaic panel 1 of rotate type are embedded in the top of the frame 34, the electronic lock or electromagnet 7 are installed on the back of the frame 34, and are fixed on the tubular drive device 36 through a bracket 35, but the electronic lock or electromagnet 7 are not installed at the connection with the tubular drive device 36, the tubular driving device 36 is fixed on the top surface of the bracket 38 through the bracket 37, the bracket 38 is the cover of the sleeve 12, but is not connected to the top of the sleeve, the bracket 38 is fixed on the turntable 29 and rotates with the turntable 29, the beam 26 in the anti-wind device on the safety beam 8 are connected with the bracket 37, the installation method of the safety beam 8 and the turntable 29 is the same as that of the above-mentioned lift-type 2-dimensional tracking, and connect the waterproof male and female connectors between the angle tracking controller, the motor and the battery to each other, and the installation of the 2-dimensional tracking photovoltaic power generation device is completed.

### Preferred Embodiment of the Invention

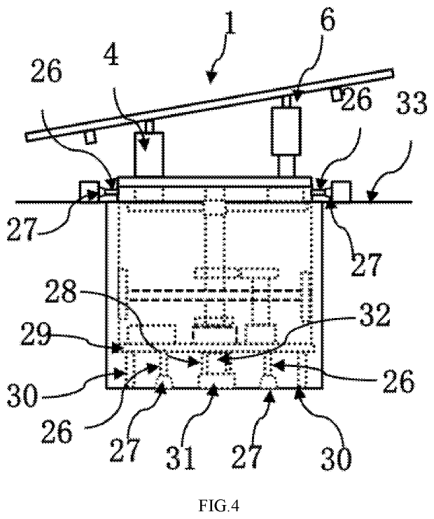

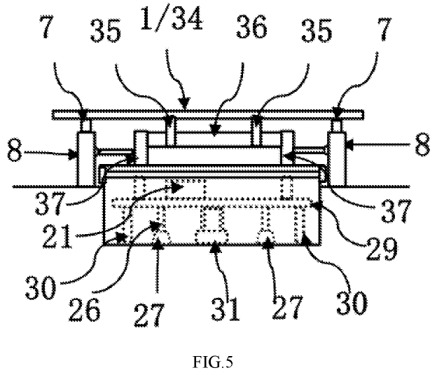

Refer to FIGS. 1-4, during the driving process of the vehicle, the photovoltaic panel 1 is horizontally fixed on the safety beam 8. at this time, the mode of the fixed bracket is used to generate electricity, please refer to FIG. 2. when tracking is required, when the vehicle is stable in the parking lot, after turn on the adjustment switch in the cab or activate the switch through the APP, and the electronic lock on the photovoltaic panel 1 and the safety beam 8 are opened or the electromagnet are powered off, the photovoltaic panel 1 and the safety beam 8 are separated, first, the rising of the pallet 15 is adjusted. the angle tracking controller controls the motor 24 to rotate, drives the gear 13 to rotate through the motor shaft 25, and drives the gear 16 to rotate and the rotation shaft 5 to rotate, thereby making the tray 15 rise, when the top of the pallet 15 is flush with the vehicle roof 33, the pallet 15 stops rising, the photovoltaic panel 1 rises in place, and is in a horizontal state, and the motor 24 is self-locking, please refer to FIG. 3. at the predetermined angle adjustment moment, first adjust the azimuth angle, the angle tracking controller adjusts the timetables according to the azimuth angle pre-entered in the storage module with it, the shaft 32 is driven by the motor 31 to rotate, and the turntable 29 is rotated around the shaft 32 through the universal wheel 30 to make a circular motion at the bottom of the sleeve 12, the beam 26 in the anti-wind device on the vehicle roof and the bottom of the sleeve also makes a circular motion with the rotation of the base pillar 9 and the sleeve 12, the overall direction of the base pillar 9 will be toward the east or west with the rotation of the turntable 29, so that the azimuth angle of the photovoltaic panel 1 will be changed, thereby completing the adjustment of the azimuth angle, then adjust the inclination angle. in several adjustment modes, the angle tracking controller is based on the inclination value pre entered in the storage module θ or 0, at the beginning of the morning period, the control motor 17 drives the shaft 18 to rotate and drives the hollow tube 6 to rise to the height of H1, and pushes the photovoltaic panel 1 to change from a horizontal state to an inclined state, please refer to FIG. 4, during the noon period, the hollow tube 6 is lowered by the height of H1, pulling the photovoltaic panel 1 from the inclined state to the horizontal state, please refer to FIG. 3, the adjustment in the afternoon is the same as that in the morning, after the photovoltaic panel 1 is adjusted in place, it will stand still until the next adjustment time. in the mode of many times adjustment, when the predetermined adjustment time is reached, inclination value output a by multi axis angle sensor or inclination sensor which sent to the main controller of the main chip after being converted by the analog-to-digital converter, the main controller controls the motor 17 to rotate according to the inclination angle value α, the drive shaft 18 rotates and drives the hollow tube 6 to rise or fall, so that the inclination angle of the photovoltaic panel 1 is adjusted to α, the adjusted inclination value is again converted by the analog-to-digital converter and sent to the main controller of the main chip, the main controller then compares the input value with the inclination angle value α to determine whether the inclination angle of the photovoltaic panel 1 that has been adjusted in place is within the error range, and according to this the control module of the motor 17 is controlled, thereby completing the adjustment of the inclination angle α once, when the adjustment time of the predetermined noon is reached, the hollow tube 6 is completely contracted, after the photovoltaic panel 1 is in a horizontal state, it will stand still until the next adjustment time, please refer to FIG. 3. the error detection method after azimuth adjustment is the same as that of inclination angle, but it is completed by controlling the rotation of turntable 29. when storing, after the angle tracking controller adjusts the photovoltaic panel 1 to be in a horizontal state, it adjusts the pallet 15 to descend, the way of adjustment is just the opposite of the way of rising, when the electronic lock or electromagnet 7 of the photovoltaic panel 1 is connected to the electronic lock or electromagnet 7 of the safety beam 8, after the electronic lock or electromagnet 7 is closed or powered on and locked, the photovoltaic panel 1 is fixed on the safety beam 8, indicates that both the photovoltaic panel 1 and the pallet 15 have returned to their positions, the pallet 15 is stationary, the motor 24 is self-locking, when the vehicle is started, and the photovoltaic panel 1 is not return to its position, a warning alarm will sound in the cab. when an emergency occurs, the photovoltaic panel 1 can be controlled to return to its position through a remote control or a mobile phone.

Refer to FIGS. 5-6, during the driving process of the vehicle, the photovoltaic panel 1 is horizontally fixed on the safety beam 8, at this time, the mode of the fixed bracket is used to generate electricity, please refer to FIG. 5. when tracking is required, when the vehicle is stable in the parking lot, after turn on the adjustment switch in the cab or activate the switch through the APP, and the electronic lock on the photovoltaic panel 1 and the safety beam 8 are opened or the electromagnet are powered off, first, the adjustment frame 34 is raised, the inclination angle adjustment in several adjustment modes, the angle tracking controller controls the rotation of the motor in the tubular drive, and rotates the same angle according to the inclination value in the storage module, the photovoltaic panel forms a tilted state, please refer to FIG. 6, during the noon period, after the turning angle of the tubular drive device is changed to 0, the frame 34 is stationary on the safety beam, please refer to FIG. 5, then adjust the azimuth angle, the adjustment method is the same as the lifting type, at this time, the bracket 38 rotates in the same direction with the turntable 29, and the top of the bracket 38 moves in a circular motion around the sleeve 12, and drive the photovoltaic panel 1 in the frame 34 to rotate, so that the azimuth angle of the photovoltaic panel 1 changes. in the many times adjustment mode, the principle of inclination angle adjustment is the same as that of the lifting type, the angle tracking controller drives the tubular drive device 36 to rotate at an angle α according to the real-time inclination angle value α, the frame 34 is driven to rotate, so that the inclination angle of the photovoltaic panel 1 is converted into α, thereby completing the adjustment of the inclination angle α once. during the noon period, it is the same as the above-mentioned several adjustment modes.

### INDUSTRIAL APPLICABILITY

A vehicle-mounted photovoltaic power generation device for a large vehicles of the present invention is installed with a tracking bracket in the fixed bracket, this tracking-type and fixed-type integration technology is simple in technology and low in cost, it not only enhances the wind resistance, but also builds a 2-dimensional tracking photovoltaic power generation device without photoelectric sensors, improve the efficiency of power generation, reduce the use of municipal electricity, and alleviating the problem of insufficient cruising range of large new energy vehicles, in addition, it solves the technical problems in the field of new energy vehicles that large vehicles mounted photovoltaic power generation devices should not only be able to track, but also have practical value, the power generation efficiency of the present invention is more than 40% higher than that of the current fixed installation mode on average, it has played a positive and beneficial effect on the sustainable development of the new energy vehicle field in the post-carbon neutral era.

What is claimed is:

1. A vehicle-mounted photovoltaic power generation device for large vehicles, which includes a turntable, a tracking bracket, and the photovoltaic panels, the tracking bracket is a 2-dimensional tracking, which is divided into two modes: lifting or rotating, in the lifting-type 2-dimensional tracking mode, it includes the photovoltaic panels, motor, the gear, the base pillar, the shaft, the pallet, the safety beam, the pillar, electronic locks or electromagnets, there are two types of electronic locks, the first is an electronic lock using RFID technology, which divided into three different types, namely passive RFID and active RFID and semi-active RFID, the second is the electronic lock using wireless network technology, and the shape of the pallet, the base pillar, and the pillar is polygonal or circular, an I-shaped plate is fixed above the shaft A of the motor A and the rotating shaft A, and the two wings of the I-shaped plate are fixed on the base pillar, there are two adjacent round holes on the I-shaped plate, and bearings are installed at the round holes, the rotating shaft A passes through the round hole in the center, the lower end is connected to the bearing, and the bearing is fixed on the bracket, the shaft A of the motor A passes through another round hole, and the bearing bracket and the casing of the motor A are fixed at the bottom of the base pillar, a pair of gears A and B are correspondingly installed on the shaft A and the rotating shaft A on the I-shaped plate, and the gears A and B mesh with each other, the hollow tube in the center of the pallet is threaded with the rotating shaft A, and moves up and down on the rotating shaft A, the three pillars are fixed on the pallet in a triangular shape, the pillars are divided into two types: pillar C and pillar D, two pillars C are installed side by side in a row, pillar D is installed in the middle of the two pillars C, a polygonal or circular plate or lid is fixed at the top of each pillar, the hinged or fixedly connected member is respectively installed on the top of pillar C or pillar D, the pillar D is a lifting electric pillar, including motor B, rotating shaft B, hollow tube B, the hollow tube B is headedly connected with the rotating shaft B, and moves up and down on the rotating shaft B, the rotating shaft B is fixed on the shaft of the motor B, and the height of the three pillars is the same, the length of the hollow tube B is the same as the height H of the rotating shaft B, H1 is the height of the hollow tube B ascending and descending, ½ H≤H1≤⅔ H, the top of the base pillar is fixed with a cover, which is not connected with the three pillars, and the top of the rotating shaft A is fixed on the cover through a bearing, a battery is installed at the bottom of the base pillar, the top of the base pillar protrudes on the top surface of the vehicle roof, and the bottom is fixed on the turntable, the turntable is a polygonal or circular T-shaped pillar, the universal wheels are installed around the bottom surface of the turntable, and the anti-wind device is installed between the universal wheels and the hollow tube of the turntable, the anti-wind device is composed of beams and grooved track, one end of the beam is hinged or fixed on the bottom surface of the turntable, and the other end is fixed with a polygonal or circular fastener, which is inserted into the groove track, the shape of the groove track is circular, the cross section is trapezoidal, and it is fixed at the bottom of the sleeve, the sleeve is a polygonal or circular hollow column, the hollow tube of the turntable is fixed on the shaft C of the motor C, and the casing of the motor C is fixed on the bottom of the sleeve, a dust-proof belt is installed between the top of the sleeve and the base pillar, its material is divided into two types: rigid material or soft material, and it is flush with the roof of the vehicle, the rigid dust-proof belt is not connected with the base pillar, while the soft dust-proof belt can be connected with the base pillar, the side walls and bottom of the sleeve are fixed on the support frame, and the support frame is fixed on the frame of the vehicle body, a polygonal or circular safety beam is installed on the roof of the vehicle, and the above electronic locks or electromagnets are installed in the safety beam, between the inner side of the safety beam and the protruding part of the base pillar, the above-mentioned anti-wind device is installed, install grooved rails or beams on its inner side, the sides of the protruding parts of the base pillar are hinged or fixedly mounted with beam with fastenings or fixedly mounted track, the quantity of photovoltaic panels are divided into two types, piece or multiple, when there are multiple photovoltaic panels, multiple photovoltaic panels are fixed as a whole by using T-shaped plates and fixing members, the hinged or fixed components corresponding to the pillars C or D are installed on the back of the photovoltaic panel or on the T-shaped panel, the electronic locks or electromagnets corresponding to the safety beam are also installed on the back of the photovoltaic panel, in the rotary-type 2-dimensional tracking mode, it includes the turntable, the Π-shaped or I-shaped bracket, the tubular drive, the sleeve, the safety beam, and the frame, the shape of the frame is polygon or circle, the electronic locks or electromagnets are installed on the back of the frame, and one end of the frame is fixed on the hollow tube in the tubular drive device, the tubular driving device includes a hollow tube, the tubular motor, driving wheels or gears, the drive wheels or gears are connected to the motor shaft and fixed inside the hollow tube, the tubular motors are placed in the hollow tube, and the tubular motors are fixed on the motor bases, the motor bases are fixed on the fastening components, and the two ends of the hollow tube are respectively connected to the runner of the fastening component, and the fastening component is fixed on the bracket, the bracket is fixed on the Π-shaped or I-shaped bracket, and the bottom of the Π-shaped or I-shaped bracket is fixed on the turntable, the top is the cover of the sleeve, which is suspended on the top of the sleeve and is not connected to it, and is circular in shape, the anti-wind device on the safety beam is connected with the bracket of the fastening component, and the photovoltaic panels are installed in the frame, the top surface of the sleeve protrudes or recesses into the vehicle, when recessed into the vehicle, the top surface of the Π-shaped or I-shaped bracket is flush with the roof surface of the vehicle, the drive of the motor will be controlled by the angle tracking controller, the electronic module of the controller includes the main chip, multi-axis angle sensor or tilt sensor, GPS satellite positioning, clock chip, and motor drive module, the angle tracking controller is mounted parallel on the back of the photovoltaic panel, about the adjustment of the azimuth angle, in the morning and afternoon time periods, it is adjusted every δ minutes, and no adjustment is made at noon time period, the adjustment of the inclination angle is divided into two types: several adjustments within 3 times a day or many times adjustments more than 3 times, the angle tracking controller adopts the working principle of non-inductive tracking without photoelectric sensors, about the adjustment of inclination angle, when it is a lifting-type 2-dimensional tracking mode, in several adjustment modes, a fixed inclination angle is used to adjust, the rising height of the pillar D in the morning and afternoon periods is H1, and the lowering height in the noon period is H1, and the corresponding inclination angle value is θ or 0, input the inclination angle value of θ, 0 and the corresponding time period into the memory module of the controller in advance, when receiving the adjustment signal, the angle tracking controller adjusts the height of the rising or lowering H1 of the pillar D according to the inclination angle of θ or 0; in the many times adjustment mode, real-time inclination is used to adjust, in the morning and afternoon time periods, the inclination angle is adjusted λ times within δ minutes, and no adjustment at noon time period, input the adjust timetable into the memory module of the controller in advance, it uses the module or inclination sensor in the multi-axis angle sensor to detect the angle value in real time to determine the size of the inclination angle adjustment, the inclination angle α at the beginning of each adjustment is the real-time inclination angle at that time, the multi-axis angle sensor module is divided into 3 combination types: the first combination is multi-axis gyroscope and multi-axis acceleration, the second combination is multi-axis gyroscope and multi-axis angle, and the third combination is multi-axis gyroscope and multi-axis acceleration and multi-axis angle, when receiving the adjusted signal, the core chip of the multi-axis angle sensor or the inclination sensor uses its own digital operation processor to go through the algorithm of attitude calculation or Kalman filtering, the real-time inclination value α after the operation is output through the main interface, and sent to the main controller of the main chip after being converted by the analog-to-digital converter, the main controller drives the rising or lowering of the pillar D according to the inclination angle value α, so that the inclination angle adjustment of the photovoltaic panel becomes α, the adjusted inclination angle value is again converted by the analog-to-digital converter and sent to the main controller of the main chip, the main controller then compares the input value with the inclination angle value α to determine whether the inclination angle of the photovoltaic panel that has been adjusted in place is within the error range, and according to this, the motor control module of the pillar D is controlled, so as to complete the adjustment of the inclination angle α once, in the rotating 2-dimensional tracking mode, the inclination angle of the photovoltaic panel is the same as the rotation angle of the tubular drive device, in the mode of several adjustments is the same as the lift type, a fixed inclination angle is used as well, the rotation angle of the tubular drive device in three time periods is the same as the inclination angle values β and 0 in the memory module; in the mode of many times adjustment is the same as the lift type, but the adjustment of the inclination angle α is completed by driving the tubular drive device to rotate the angle of α, the adjustment of the azimuth angle, the adjustment of the azimuth angle of the lift mode and the rotary mode are the same, the timetable of δ times adjustment is input into the memory module of the controller in advance, when the predetermined adjustment time is reached, the angle tracking controller receives the GPS real-time positioning information, through the calculation of the control module of the main chip, a real-time azimuth angle value φ facing east or west is obtained, the main controller drives the turntable rotation angle φ according to the azimuth angle φ, so that the azimuth angle of the photovoltaic panel is transformed into φ, the error detection method after azimuth adjustment is the same as that of inclination angle, it is characterized in that: the tracking bracket is installed in the fixed bracket, which not only enhances the wind resistance performance, but also builds a 2-dimensional tracking type and fixed type integrated photovoltaic power generation device without photoelectric sensors, the angle adjustment of the photovoltaic panel will adopt time timing, and implementation by the angle tracking controller which will control the rotation of the turntable or the rising or lowering of the pillar D or the rotation of the tubular drive device respectively.
